(19) United States
(12) Patent Application Publication
(10) Pub. No.: US 2024/0188553 A1
(43) Pub. Date: Jun. 13, 2024

(54) AGITATION PRESSURE CONTROL SYSTEM IN AN AGRICULTURAL VEHICLE

(71) Applicant: CNH Industrial Brasil Ltda., Nova Lima (BR)

(72) Inventor: Thiago Kato Perez, Piracicaba (BR)

(21) Appl. No.: 18/529,369

(22) Filed: Dec. 5, 2023

(30) Foreign Application Priority Data
Dec. 9, 2022 (BR) 10 2022 025263 7

(51) Int. Cl. A01M 7/00; A01C 23/00; A01C 23/04

(52) U.S. Cl. CPC A01M 7/0089; A01C 23/008; A01C 23/047; A01M 7/0042; A01M 7/0085

(57) ABSTRACT

An agitation pressure control system in an agitation system of an agricultural vehicle includes a first valve in an agitation line and a second valve in a spray line, the spray and agitation lines being fluidly connected to a hydraulic pump via a T connection.

### FIELD OF INVENTION

The present invention refers, in a general way, to agricultural spray apparatuses and, more particularly, to a system for controlling agitation pressure in an agitation system of an agricultural vehicle and to a method for controlling an agitation pressure control system in an agitation system of an agricultural vehicle.

### BACKGROUND OF THE INVENTION

Agricultural sprayers apply an agricultural fluid (for example, a pesticide, a nutrient and/or similar) to the cultures while the sprayer is moving through a field. To facilitate this movement, the sprayers are configured as self-propelled vehicles or implements towed behind an agricultural tractor or other suitable work vehicle. A typical sprayer includes a bar set wherein there are assembled a plurality of spaced nozzles. Each nozzle is configured to disperse or spray the agricultural fluid in the underlying cultures and/or field surface.

There exist several configurations of agricultural sprayers in the state of the art. For example, patent document U.S. Ser. No. 10/426,080B2 discloses a mobile turf sprayer able to identify a plurality of regions of the turf site to be sprayed, such as, for example, golf courses, sports fields, municipal parks, schools, university campuses etc. and automatically spray products on these regions as the sprayer moves about the turf site. Each region of a plurality of regions can present different characteristics and, therefore, must be treated in a different manner. For example, product flows, types of products and frequency of application of products can vary depending on the characteristics of each region.

Another agricultural sprayer configuration is shown in patent document U.S. Pat. No. 5,050,995A, which refers to an apparatus for mixing and dispersing fluid based products and, more specifically, to an apparatus for mixing seeds, a retaining media, such as paper mulch and water prior to application to the soil. In particular, the apparatus of this patent document guarantees that the components of an agricultural seeding mixture, particularly the vegetable paper fiber mulch, be broken into functional size flakes and fibers and suitable for application to the soil, which avoids clogging hoses, inlets, and valves of the apparatus. The apparatus comprises four manual valves which can be adjusted to regulate the flow of the fluid product back to a product tank or toward a sprayer.

Yet another agricultural sprayer configuration is shown in patent document EP3085229B1, which provides a liquid circuit which acts in an excellent manner in an agitation process of a liquid contained in the storage container of a sprayer system. For this purpose, the discharge rate and/or agitation process are adjusted by means of an electronic control unit through the adjustment of the valve positions of the control valves that control the liquid circuit, based on data from at least two measuring devices. The control guarantees that part of the pumping power, which is not required for discharging the material, serves for circulating and/or agitating the material in the storage container. This makes it possible to always use the greatest possible proportion of the pumping power for operating the agitator.

As can be seen from the above patent documents, it is common for the agricultural sprayers of diverse configurations of the state of the art to include agitation and spray systems, designed, respectively, to agitate the agricultural fluid within the tank and to spray the agricultural fluid at the location of application. These agitation and spray systems can, in one of the possible configurations of the state of the art, be hydraulically driven using the same hydraulic pump. In this configuration, the hydraulic circuit common to both agitation and spray systems receives from the pump the fluid to be applied, which is divided in the agitation and spray lines. The agitation line proceeds to the agitation system, which essentially returns part of the fluid to the tank, causing agitation in the interior thereof, and the spray line proceeds to the spray system, responsible for the application of the agricultural product.

It occurs that the pump rotation, common to both systems, is governed by the amount of material (flow) that the spray system must receive, so that the flow and pressure in the agitation system are tied to these conditions of the spray system.

This particular configuration of the state of the art, which can present a valve in the controllable agitation line (for example, by means of a lever in the cabin of the agricultural vehicle) to be completely closed (zero flow), can be gradually opened until it reaches a maximum open state (maximum flow). Thus, since the pump rotation is governed by the product flow required by the spray system, it is only possible to reach an agitation pressure which is equal to the spray pressure (assuming, for the sake of simplification, zero loss of load). In this particular configuration, the only way to reach different agitation and spray pressures is by the gradual closing of the valve in the agitation line, which causes a drop in the agitation pressure. In other words, the agitation pressure can only be lower than (if the valve is partially closed) or equal to (if the valve is fully open) the spray pressure.

This characteristic can be particularly unfavorable in a situation wherein the spray is being applied at a relatively low pressure, since the agitation pressure will at the most equal this relatively low spray pressure, which can cause the agitation system not to provide an adequate agitation for the product inside the tank, even if the valve in the agitation line is fully open. This can cause homogenization problems in the material to be applied which can, in turn, generate variable and unsuitable concentrations in the fluid product and possible clogging in the hydraulic circuit.

Consequently, a system and method which allows the control of the agitation pressure independent of the spray pressure, in particular which allows higher agitation pressures in relation to the spray pressure, are desired in the technology.

### BRIEF SUMMARY OF THE INVENTION

The aspects and advantages of the invention will be presented, in part, in the following description, or they may be obvious from the description, or they can be apprehended by putting the invention into practice.

The present invention refers to a system for controlling agitation pressure in an agitation system of an agricultural vehicle. The control system comprises a tank containing a fluid based material and a hydraulic circuit. The hydraulic circuit comprises a hydraulic pump, wherein a hydraulic pump inlet is fluidly connected to the tank, a T connection downstream of the hydraulic pump and comprising a connection inlet and two connection outlets, wherein the connection inlet is fluidly connected to the hydraulic pump, a first connection outlet is fluidly connected to an agitation line and a second connection outlet is fluidly connected to a spray line. The agitation line comprises a first valve and the spray line comprises a second valve.

According to additional or alternative embodiments of the present invention, the following characteristics, and possible variations thereof, can also be present, by themselves or in combination:
the second valve is an electronic valve;
the spray line comprises an outlet located downstream of the second valve and is fluidly connected to a spray system of the agricultural vehicle;
the agitation line comprises an outlet located downstream of the first valve and is fluidly connected to the tank;
the outlet of the agitation line is fluidly connected to the tank by means of at least one venturi nozzle;
the spray line comprises a flow meter upstream of the second valve;
the hydraulic pump is a centrifugal pump;
the agricultural vehicle is a self-propelled agricultural sprayer, the agricultural sprayer comprising an operator cabin;
the operator cabin comprises at least one control lever for controlling the first valve and the second valve;
the at least one control lever consists of only one control lever which controls the first valve and the second valve;
the at least one control lever comprises a first valve control lever and a second valve control lever.

In order to overcome the above cited inconveniences of the state of the art, among others, the present invention further relates to a method for controlling the agitation pressure control system in an agitation system of an agricultural vehicle. The agitation pressure control system comprises a first valve in an agitation line and a second valve in a spray line, and the method comprises the following steps:
starting an agitation pressure control having the second valve fully open;
opening the first valve until the agitation pressure reaches a desired value or the first valve reaches a fully open state; and
if the agitation pressure is below the desired value even after the first valve reaches the fully open state, gradually closing the second valve until the agitation pressure reaches the desired value.

According to additional or alternative embodiments of the present invention, the following characteristics, and possible variations thereof, can also be present, by themselves or in combination:
the step of opening the first valve and the step of gradually closing the second valve are performed by an operator by means of at least one control lever in an operator cabin of the agricultural vehicle;
the at least one control lever consists of only one control lever for controlling the first valve and the second valve, wherein the step of opening the first valve is performed by the operator by moving the control lever to a determined position and holding the control lever at the determined position until the agitation pressure reaches the desired value or the first valve is fully open, and the step of gradually closing the second valve is performed by the operator by continuing to hold the control lever at a determined position after the first valve is completely open until the agitation pressure reaches the desired value; and
the at least one control lever comprises a first valve control lever and a second valve control lever, wherein the step of opening the first valve is performed by the operator by moving the first valve control lever to a determined position and holding the first valve control lever at the determined position until the agitation pressure reaches the desired value or the first valve is fully open and the step of gradually closing the second valve is performed by the operator by, after the first valve is completely open, moving the second valve control lever to a determined position and holding the second valve control lever until the agitation pressure reaches the desired value.

These and other aspects, functions and advantages of the present invention will be better understood with reference to the following description and the attached claims. The attached drawings, which are incorporated and constitute a part of this specification, illustrate the embodiments of the invention and, together with the description, serve to explain the principles of the invention.

### BRIEF DESCRIPTION OF THE FIGURES

A complete and enabling description of the present invention, which includes the best embodiment thereof, directed to a person skilled in the art, is presented in the specification, which refers to the attached figures, wherein:

FIG. 1 illustrates a perspective view of an embodiment of a work vehicle according to aspects of the present matter;

FIG. 2 illustrates a side view of an agricultural sprayer according to aspects of the present matter, particularly showing a non-operational folded position of a first boom arm of a boom set according to aspects of the present matter;

FIG. 3 relates to a schematic drawing illustrating the hydraulic circuit of the agricultural sprayer containing components of the agitation and spray systems; and

FIG. 4 illustrates a flowchart of an embodiment of a method for controlling an agitation pressure control system in an agitation system of an agricultural vehicle.

### DETAILED DESCRIPTION OF THE INVENTION

Reference will now be made, in detail, to the embodiments of the invention, whereby one or more examples of same are illustrated in the drawings. Each example is provided as an explanation of the invention, without limiting the invention. In fact, it will be evident to those skilled in the art that several modifications and variations can be made in the present invention, without departing from the scope or spirit of the invention. For example, the functions illustrated or described can be used with another embodiment to further produce an additional embodiment. In this manner, the present invention must cover said modifications and variations as they are presented in the scope of the attached claims and equivalents thereof.

In this document, the related expressions, such as first and second, upper and lower, and similar, are used only to distinguish an entity or action from another entity or action without necessarily requiring or implying any relation or real order between said entities or actions. The expressions “comprising”, “which comprises”, or any other variation of same, must cover a non-exclusive inclusion, so that a process, method, article, or apparatus which comprises a list of elements does not include solely those elements, but also includes other elements that are not expressly listed or inherent to said process, method, article, or apparatus. An element preceded by “comprising . . . a(an)” does not, without additional restrictions, prohibit the existence of additional identical elements in the process, method, article or apparatus that comprises the element.

As used in the present document, the expression “and/or”, when used in a list of two or more items, means that any one among the listed items can be used by itself or any combination of two or more listed items can be used. For example, in case a composition or set is described as containing components A, B and/or C, the composition or set can contain only A; only B; only C; A and B combined; A and C combined; B and C combined; or A, B and C combined.

In a general manner, an embodiment of the present invention refers to an agitation pressure control system of an agricultural vehicle and to a method for controlling an agitation pressure control system in an agitation system of an agricultural vehicle. The agitation system of the agricultural vehicle is provided so as to be fluidly connected to a spray system of the agricultural vehicle.

The agricultural vehicle includes a tank containing a fluid based material, and a hydraulic circuit including a hydraulic pump, wherein a hydraulic pump inlet is fluidly connected to the tank. The hydraulic circuit includes a T connection downstream of the hydraulic pump, the T connection including a connection inlet and two connection outlets. The connection inlet is fluidly connected to the hydraulic pump, a first connection outlet is fluidly connected to an agitation line and a second connection outlet is fluidly connected to a spray line. The agitation line includes a first valve, and the spray line includes a second valve.

The second valve in the spray line is aimed at allowing the independent control of the agitation pressure, as will be explained in more detail ahead.

The method for controlling an agitation pressure control system includes a step of starting an agitation pressure control with the second valve in the spray line fully open. The method further includes a first step of opening the first valve in the agitation line until the agitation pressure reaches a desired value or the first valve reaches a fully open state. Additionally, the method includes the step of, if the agitation pressure is below the desired value even after the first valve reaches the fully open state, gradually closing the second valve until the agitation pressure reaches the desired value.

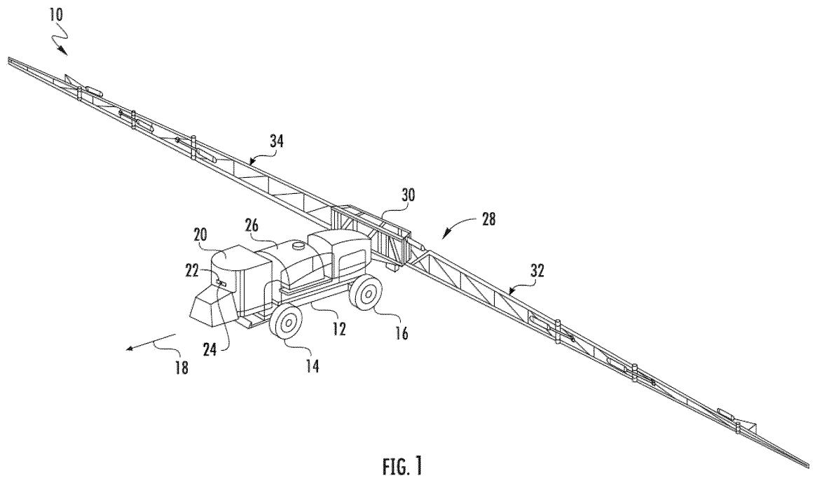

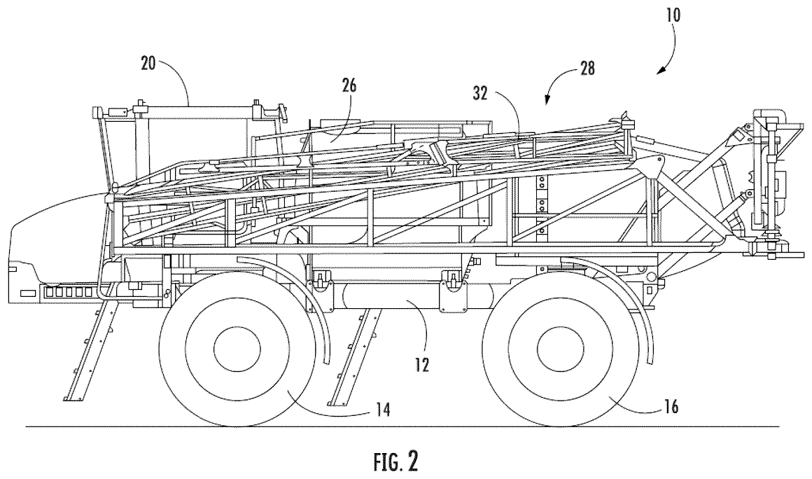

Referring now to FIGS. 1 and 2, there is illustrated an agricultural work vehicle, configured as a self-propelled agricultural sprayer. In several embodiments, the work vehicle 10 can include a chassis 12 configured to support or couple with a plurality of components. For example, front and back wheels 14, 16 can be fixed to the chassis 12. Wheels 14, 16, can be configured to support the work vehicle 10 in relation to a soil surface and move the work vehicle 10 in a course direction (for example, as indicated by arrow 18 in FIG. 1) in a field or on the soil surface. In this sense, the work vehicle 10 can include a power center, such as an engine, a drive machine, or a hybrid combination of engine-drive machine, to move the work vehicle 10 throughout the field. In some occurrences, the work vehicle 10 can further include a transmission configured to transmit power from the engine to any of the wheels 14, 16.

The chassis 12 can further support an operator station 20, such as an operator cabin, which provides several control or inlet devices (for example, levers, pedals, control panels, knobs and/or similar) to allow an operator to control the operation of the work vehicle 10. For example, as shown in FIG. 1, the work vehicle 10 can include a man-machine interface (MMI) 22 to exhibit messages and/or warnings to the operator and/or to allow the operator to interface with a vehicle controller. In some embodiments, the MMI 22 can include one or more user inlet devices 24 in the form of levers, switches, buttons, knobs and/or any other device that allows the operator to provide user input to the controller.

Additionally, the chassis 12 can further support a tank 26 and a boom set 28 mounted on the chassis 12. Tank 26 is usually configured to store or retain an agricultural substance (fluid based material), such as a pesticide, a fungicide, a rodenticide, a fertilizer, a nutrient and/or similar. The agricultural substance stored in tank 26 can be dispersed over the surface of the underlying soil (for example, plants and/or soil) through one or more dispensers (such as nozzles) mounted on the boom set 28.

As shown in FIGS. 1 and 2, the boom set 28 can include a frame which sustains first and second boom arms 32, 34 in balance. First and second boom arms 32, 34 are usually movable between and operational or unfolded position (FIG. 1) and a non-operational or folded position (FIG. 2). During the distribution of the product, the first and/or second arm boom 32, 34 extends laterally out of the work vehicle 10 so as to cover wide ranges of soil application, as illustrated in FIG. 1. However, in order to facilitate the transport, each boom arm 32, 34 of the boom set 28 can be folded independently forward or backward in the non-operational position, in this manner reducing the overall width of the vehicle 10 or, in some examples, the general width of an implement that can be towed when the sprayer is configured to be towed behind the work vehicle 10.

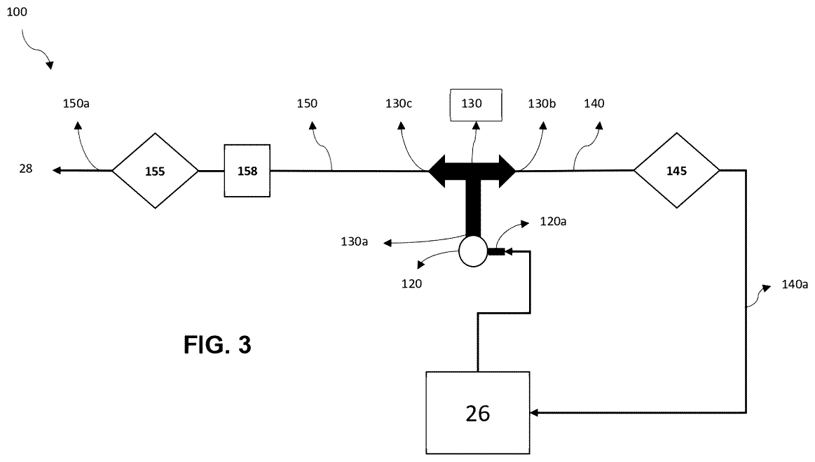

FIG. 3 illustrates, in a schematic drawing, components of a hydraulic circuit of the agitation pressure control system 100 in an agitation system of the agricultural vehicle 10. The agricultural vehicle includes tank 26 containing a fluid based material and a hydraulic circuit.

The hydraulic circuit shown in FIG. 3 includes a hydraulic pump 120, which can be, for example, a centrifugal pump, wherein an inlet 120a of the hydraulic pump 120 is fluidly connected to tank 26. Additionally, the hydraulic circuit further includes a T connection 130 downstream of the hydraulic pump 120. T connection 130 includes a connection inlet 130a, and two outlet connections 130b, 130c. The connection outlets 130b, 130c direct the fluid based material derived from the hydraulic pump 120 to an agitation line 140 and to a spray line 150, respectively.

Spray line 150 takes part of the fluid based material, ultimately, to the one or more dispensers (nozzles, for example) mounted on the boom set 28, for the material to be applied in the areas of interest. In its turn, agitation line 140 takes, under an agitation pressure, the other part of the fluid based material pumped by the hydraulic pump 120 back to tank 26, for the fluid based material contained in tank 26 to be adequately mixed prior to being pumped and sprayed. For example, an outlet 140a of agitation line 140 can be fluidly connected to the tank by means of at least one venturi nozzle.

In this manner, a homogeneous mixture is obtained in the fluid based material, avoiding variable and undesired concentrations in the sprayed material, as well as reducing the risks of clogging in the hydraulic circuit due to excessively large solid particles.

As can be seen in FIG. 3, the hydraulic circuit includes a hydraulic pump 120 wherein the pumped fluid based material is split for agitation line 140 and spray line 150. As is known by those skilled in the art, in agitation and spray systems such as the one shown in FIG. 3, wherein a single hydraulic pump 120 provides fluid to both systems, what governs the operation parameters of the pump is the amount of material to be sprayed, that is, the flow of material to be sprayed. In this way, there an be defined, for example, the pump rotation speed. In this sense, the agitation pressure in the agitation system is a consequence of the flow of material which the spray system demands.

In systems of the type, there is conventionally used a valve in the agitation line, which can vary from completely closed (zero flow) to fully open (maximum flow), which also influences the agitation pressure in the agitation system. However, said valve only allows the agitation pressure to be equal (considering, hypothetically, zero load loss), in case the valve is fully open, or lower, in case the valve is partially or completely closed to the spray pressure. This is particularly disadvantageous in case the spray is being performed under low pressure, since, even if the valve in the agitation line is fully open, the agitation pressure will be at the most equal to low spray pressure, which can cause the agitation system to not provide adequate agitation and the fluid based material remains undesirably heterogeneous and with excessively large solid particles.

In this sense, the hydraulic circuit according to one embodiment of the present invention includes, apart from a first valve 145, which can be located upstream of the outlet 140a in agitation line 140, a second valve 155, which can be an electronic valve and located upstream of an outlet 150a in spray line 150. Second valve 155 allows the agitation pressure to be controlled in an independent manner from the spray pressure, as will be explained ahead.

Considering that the amount of material to be sprayed is predefined and cannot be changed in a given operation, in case it is desired to increase the agitation pressure, first valve 145 is fully opened, so that the agitation pressure equals the spray pressure. To increase even more the agitation pressure, an operator can gradually close second valve 155, since, for the amount of sprayed material not to be altered, that is, for the flow of material in the spray system to remain the same, it is necessary to increase the hydraulic pump 120 rotation speed to compensate the restriction imposed on the flow in spray line 150 due to closing of second valve 155. Since in agitation line 140, differently from spray line 150, there is no restriction of flow, given that first valve 145 is fully open, the increase in the flow provided by hydraulic pump 120 caused by the increase of the hydraulic pump 120 rotation speed causes an increase in the agitation pressure. To help in the control and maintenance of flow in spray line 150, there can be used, for example, a flow meter 158 upstream of second valve 155.

In other words, the agitation pressure can be increased independently of the spray pressure in the dispenser (nozzle). More than that, the agitation pressure is controlled in such a manner that it is possible for it to be greater than the spray pressure, eliminating the possible problems found in a spray operation performed under low pressure. It must be highlighted that the hydraulic pumps 120 used in this type of system have sufficient capacity for the speed thereof to be increased so as to adequately compensate for the restriction imposed on spray line 150.

The control of the opening and closing of first valve 145 and second valve 155 can be carried out, for example, by at least one control lever 24 located in operator cabin 20. The at least one control lever 24 can include a single control lever which controls both first valve 145 and second valve 155 or, alternatively, a first valve control lever and a second valve control lever, each one dedicated to first and second valves 145, 155.

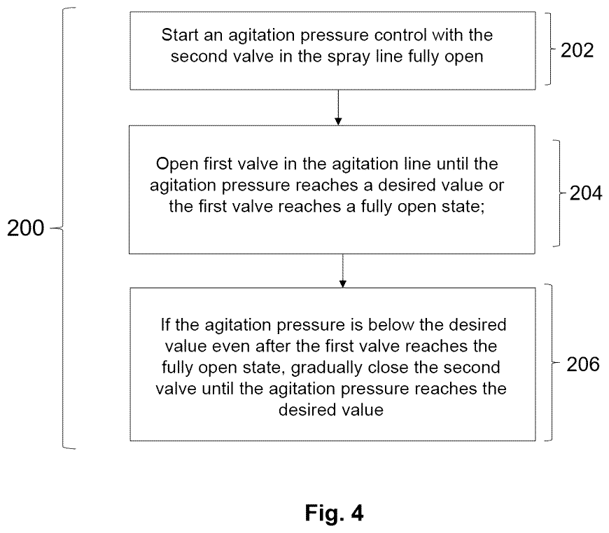

Referring now to FIG. 4, a flowchart of an embodiment of a method 200 for controlling an agitation pressure control system 100 in an agitation system of an agricultural vehicle is shown in accordance with aspects of the present matter. In a general manner, method 200 will be described in the present document with reference to the above cited work vehicle 10 and the hydraulic circuit with reference to FIGS. 1 to 3. However, a person skilled in the art must observe that method 200 can be implemented in a general manner with any machine/agricultural spray set which has an adequate machine/set configuration for agricultural sprayer and/or any system having any adequate system configuration. Additionally, although FIG. 4 describes steps carried out in a particular order with purposes of illustration and discussion, the methods discussed in this document are not limited to any particular order or arrangement. A person skilled in the art, using the disclosure provided in this document, will observe that several steps of methods disclosed in the present document can be omitted, rearranged, combined and/or adapted in several manners, without deviating from the scope of the present disclosure.

As shown in FIG. 4, in 202, method 200 can include starting an agitation pressure control with second valve 155 in spray line 150 fully open. As described above, in this situation the agitation pressure can be, at the most, equal to the spray pressure, in case first valve 145 is fully open and disregarding eventual load losses in each line 140, 150.

Additionally, in 204, method 200 can include opening first valve 145 in agitation line 140 until the agitation pressure reaches a desired value or first valve 145 reaches a fully open state. As explained above, in this situation, the agitation pressure is gradually increased, as first valve 145 is opened, until it reaches a desired value, suitable for a correct agitation of the material to be sprayed in tank 26, or until first valve 145 reaches a fully open state wherein the agitation pressure equals the spray pressure, if the desired value is not reached during the opening of first valve 145.

Finally, in 206, the method can include, if the agitation pressure is below the desired value even after first valve 145 reaches the fully open state, gradually closing second valve 155 until the agitation pressure reaches the desired value. As previously explained, with the closing of second valve 155, the rotation of hydraulic pump 120 is increased for the flow of material to be sprayed to be maintained in the dispensers (nozzles) and, with this, the agitation pressure which was substantially equal to the spray pressure before the gradual closing of second valve 155, is increased until reaching the desired value, adequate for the correct agitation of the material to be sprayed in tank 26.

For the operator to monitor the agitation pressure, the hydraulic circuit can include one or more pressure sensors on agitation line 140 or integrated to first valve 145, such as, for example, a differential pressure sensor, a gage sensor, an absolute pressure sensor, or any other suitable pressure sensor known to the state of the art. The one or more pressure sensors can communicate with the controller of agricultural vehicle 10 and transmit information to the operator through the MMI 22.

Optionally, steps 204 and 206 of method 200 can include an operator moving a control lever 24 to a determined position until the agitation pressure reaches the desired value or first valve 145 is fully open, and further include the operator continue holding the control lever in a determined position, making second valve 155 begin to close, after first valve 145 is fully open, until the agitation pressure reaches the desired value.

Alternatively, steps 204 and 206 of method 200 can include an operator moving a control lever from the first valve to a determined position and holding the first valve control valve in the determined position until the agitation pressure reaches the desired value or first valve 145 is fully open, moving second valve control lever to a determined position, making second valve 155 start to close, and holding second valve control lever, until the agitation pressure reaches the desired value.

With the system and method disclosed throughout this specification, it is possible, as shown, to control the agitation pressure in an independent manner from the spray pressure in an agricultural sprayer, which allows that, even in spray operations under low pressure, an adequate agitation is provided by the agitation system to the fluid based material contained in the tank, which will be sprayed. This prevents the fluid based material from being sprayed with variable and/or undesired concentrations, and avoids eventual solid particles in the fluid based materials from decanting and/or not being adequately diluted and clogging components of the hydraulic system, which can cause financial losses due to breakage of components and/or the need to stop the agricultural machine for maintenance, reducing productivity in the field.

This written specification uses examples to describe the invention, including the best mode, and also to allow any person skilled in the art to practice the invention, including producing and using any devices or systems and performing any incorporated methods. The patentable scope of the invention is defined by the claims and can include other examples which occur to those skilled in the art. Said other examples are destined to be covered by the scope of the claims, if same include structural elements that do not differ from the literal language of the claims, or if same include structural equivalent elements with non-substantial differences from the literal language of the claims.

1. An agitation pressure control system in an agitation system of an agricultural vehicle comprising:
a tank containing a fluid based material; and
a hydraulic circuit, wherein the hydraulic circuit comprises:
a hydraulic pump, wherein an inlet of the hydraulic pump is fluidly connected to the tank;
a T connection downstream of the hydraulic pump, wherein the T connection comprises a connection inlet and two connection outlets, the connection inlet is fluidly connected to the hydraulic pump, a first connection outlet of the two connection outlets is fluidly connected to an agitation line, and a second connection outlet of the two connection outlets is fluidly connected to a spray line;
the agitation line comprising a first valve;
wherein the spray line comprises a second valve.

2. The agitation pressure control system according to claim 1, wherein the second valve is an electronic valve.

3. The agitation pressure control system according to claim 1, wherein:
the spray line comprises an outlet downstream of the second valve, wherein the outlet of the spray line is fluidly connected to a spray system of the agricultural vehicle; and
the agitation line comprises an outlet which is downstream of the first valve and is fluidly connected to the tank.

4. The agitation pressure control system according to claim 3, wherein the outlet of the agitation line is fluidly connected to the tank via at least one venturi nozzle.

5. The agitation pressure control system according to claim 1, wherein the spray line comprises a flow meter upstream of the second valve.

6. The agitation pressure control system according to claim 1, wherein the hydraulic pump is a centrifugal pump.

7. The agitation pressure control system according to claim 1, wherein the agricultural vehicle is a self-propelled agricultural sprayer, and the self-propelled agricultural sprayer comprising an operator cabin.

8. The agitation pressure control system according to claim 7, wherein the operator cabin comprises at least one control lever configured to control the first valve and the second valve.

9. The agitation pressure control system according to claim 8, wherein the at least one control lever consists of only one control lever which controls is configured to control the first valve and the second valve.

10. The agitation pressure control system according to claim 8, wherein the at least one control lever comprises a first valve control lever and a second valve control lever.

11. A method for controlling an agitation pressure control system in an agitation system of an agricultural vehicle, wherein the agitation pressure control system comprises a first valve in an agitation line and a second valve in a spray line, and the method comprises:
starting an agitation pressure control with the second valve fully open;
opening the first valve until an agitation pressure reaches a desired value or the first value reaches a fully open state; and
if the agitation pressure is below the desired value even after the first valve reaches the fully open state, gradually closing second valve until the agitation pressure reaches the desired value.

12. The method according to claim 11, wherein the step of opening the first valve and the step of gradually closing the second valve are performed via at least one control lever in an operator cabin of the agricultural vehicle.

13. The method according to claim 12, wherein the at least one control lever consists of only one control lever configured to control the first valve and the second valve, the step of opening the first valve is performed via moving the control lever to a position and holding the control lever at the position until the agitation pressure reaches the desired value or the first valve is fully open, and the step of gradually closing the second valve is performed via continuing to hold the control lever in another position after the first valve is fully open until the agitation pressure reaches the desired value.

14. The method according to claim 12, wherein the at least one control lever comprises a first valve control lever and a second valve control lever, the step of opening the first valve is performed via moving the first valve control lever to a position and holding the first valve control lever at the position until the agitation pressure reaches the desired value or the first valve is fully open, and the step of gradually closing the second valve is performed via, after the first valve is fully open, moving the second valve control lever to another position and holding the second valve control lever until the agitation pressure reaches the desired value.
